(19) United States
(12) Patent Application Publication
(10) Pub. No.: US 2010/0022275 A1
(43) Pub. Date: Jan. 28, 2010

(54) COMMUNICATION DEVICE AND INPUT METHOD FOR SAME USING VIRTUAL KEYBOARD

(75) Inventor: ZHI-LONG SHU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/330,575

(22) Filed: Dec. 9, 2008

(30) Foreign Application Priority Data
Jul. 23, 2008 (CN) 200810302960.8

(51) Int. Cl. H04B 1/38

(52) U.S. Cl. 455/566

(57) ABSTRACT

A communication device, capable of inputting messages when the communication device is in different orientations, includes an orientation sensing unit configured to detect a current orientation of the communication device, an interface transferring unit configured to invoke corresponding input interface to show on a screen of the communication device according to the current orientation of the communication device when the communication device is in an input mode, and a message handling unit for storing the message contents input in a first input interface and showing the message contents on a second input interface when the communication device is rotated to another orientation.

### BACKGROUND

1. Technical Field

The present disclosure relates to a communication device and an input method for the communication device using a virtual keyboard.

2. General Background

Consumers want digital products that are smaller, lighter, more functions, and bigger screens. One way to help meet the demands is to provide a virtual keyboard for electronic communication products. However, typical virtual keyboards can only be shown on the screens of the digital products in a single orientation for receiving user input. Generally, digital products, such as mobile phones, have a rectangular screen, with the shorter sides of the rectangle corresponding to the top and bottom of the screen which makes for a narrow virtual keyboard that is difficult to operate.

What is needed, therefore, is a communication device and a convenient input method.

### BRIEF DESCRIPTION OF THE DRAWINGS

FIG. 1 is a block diagram of one embodiment of a communication device, the communication device including an orientation sensing device.

FIG. 2 is a plan view of an orientation sensing device of the communication device.

FIG. 3 is a diagram illustrating a first input interface of the communication device.

FIG. 4 is a diagram illustrating a second input interface of the communication device.

FIG. 5 is a flowchart illustrating one embodiment of a method for entering input using different orientations of an input interface.

### DETAILED DESCRIPTION OF THE EMBODIMENTS

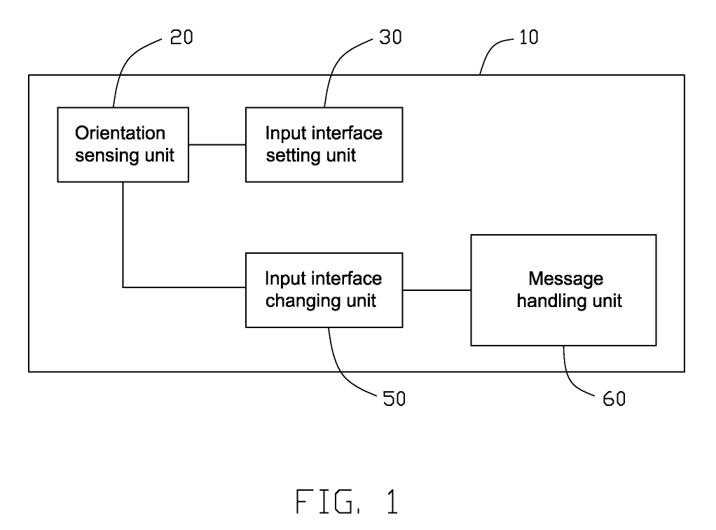

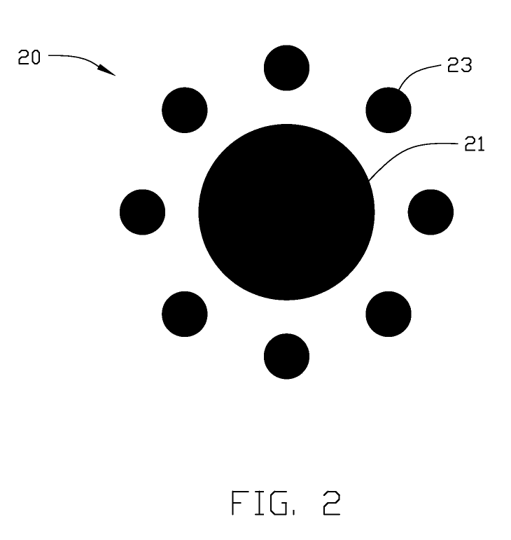

Referring to FIGS. 1 and 2, one embodiment of a communication device is provided to input messages regardless of the orientation of the communication device. In illustrated embodiment, the communication device is a mobile phone 10. An orientation sensing unit 20 is positioned in the mobile phone 10, which includes a gravity ball 21 and at least four sensing points 23 aligned in a plane parallel to a display of the mobile phone 10. The sensing points 23 are symmetrically positioned around the gravity ball 21 (shown in FIG. 2). In the illustrated embodiment, the orientation sensing unit 20 comprises eight sensing points 23 to accurately sense a changing orientation of the mobile phone 10. Each sensing point 23 corresponds to a different orientation. When an orientation of the mobile phone changes, the gravity ball 21 shifts due to gravity and presses against the corresponding sensing point 23, thereby indicating a new orientation of the mobile phone 10. The mobile phone 10 further includes an input interface setting unit 30 for setting different input interfaces to be displayed on the mobile phone 10 corresponding to different orientations of the mobile phone 10, an input interface changing unit 50 for changing the input interface displayed on the mobile phone 10 according to a current orientation of the mobile phone 10, and a message handling unit 60 for storing messages of a current input interface of the mobile phone 10 and displaying the messages in the next input interface of the mobile phone 10. The orientation sensing units 20, the input interface setting unit 30, the input interface changing unit 50, and the message handling unit 60 are electrically connected to each other. In the illustrated embodiment, four different input interfaces corresponding to four orientations of the mobile phone 10 are preset in the input interface setting unit 30.

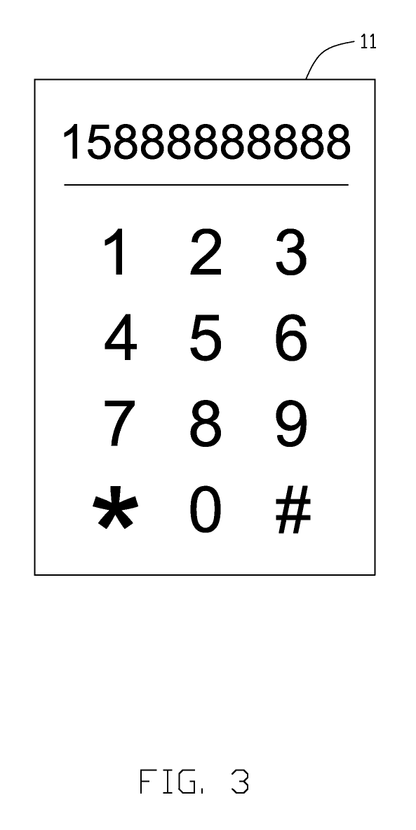

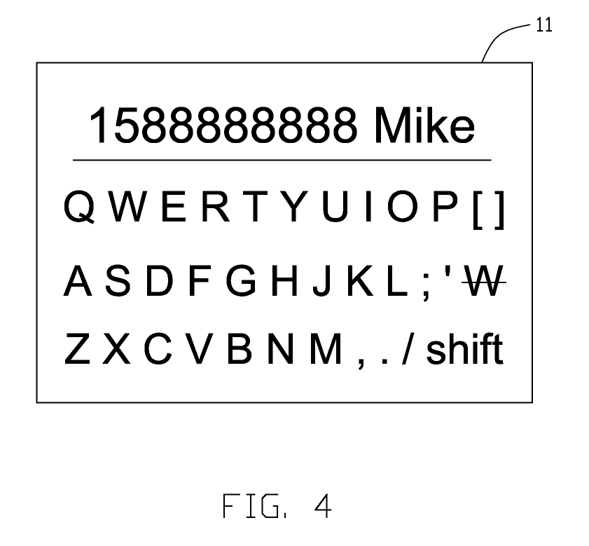

Referring also to FIG. 3 and FIG. 4, the mobile phone 10 may have a rectangular display 11. For example, when in use, the mobile phone 10 is held in a vertical direction with the keypad facing so that the mobile phone 10 is generally perpendicular to the ground. This causes the bottom sensing point 23 to be pressed by the gravity ball 21 due to gravity. If a user causes the mobile phone 10 to enter a message input mode, and the bottom sensing point 23 senses the pressure caused by the gravity ball 21, the orientation sensing unit 20 detects the current orientation, for example, a first orientation of the mobile phone 10 according to the sensing point 23 being pressed, and sends information to the interface changing unit 50 to invoke the corresponding input interface to be displayed on the screen of the mobile phone 10. A virtual keyboard corresponding to a selected input manner is shown on the display 11 of the mobile phone 10 in a first input interface mode conforming to the first orientation. For numerical input, users may select a virtual number keyboard to be displayed, and for letters, a virtual alpha keyboard may be selected, as shown in FIG. 4. The user's selection will be displayed in a manner conforming to the orientation of the mobile phone 10, for example, a vertical holding direction. If a user prefers to have an interface displayed differently for a more comfortable use, the user need only rotate the mobile phone 10, for example, to the right or clockwise, until the sensing points 23 sense the new orientation and a different interface conforming to the new orientation is displayed. For example, narrow sides of the rectangular display 11 as top and bottom of the selected virtual keyboard may be inconvenient for use and so the user can change the orientation of the mobile phone 10 so that long sides of the rectangular display 11 are oriented at the top and bottom and the interface changes accordingly. The mobile phone 10 can be rotated 90 degrees, 180 degrees, and 270 degrees from the vertical holding direction in a plane perpendicular to the ground. When the mobile phone 10 is rotated 90 degrees, a second interface is displayed. When the mobile phone 10 is rotated 180 degrees, a third input interface is displayed. A fourth input interface is displayed when the mobile phone 10 is rotated 270 degrees. It is to be understood, that even when the mobile phone 10 is rotated in a plane inclined to the ground, the sensing points 23 can still sense the orientation of the mobile phone due to gravity of the gravity ball 21, thereby changing the input interface accordingly. When the mobile phone is held in a direction parallel to the ground, such that no sensing point 23 is pressed by the gravity ball 21, the displayed input interface may be set to be the same as the last input interface or a predetermined interface.

When the input interface is changed, the message handling unit 60 stores the message contents inputted in the last input interface and displays the message contents in the new input interface. Thus, users can continue to input or edit messages in the new input interface.

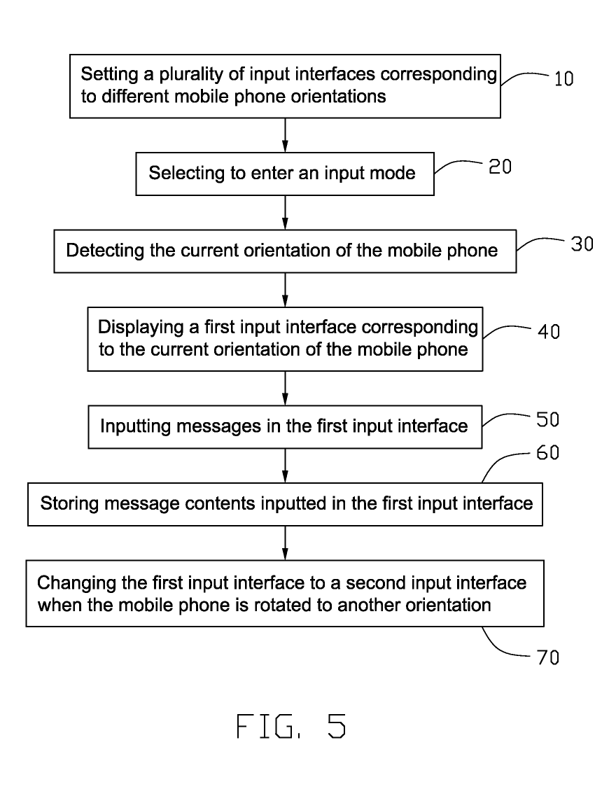

FIG. 5 is a flowchart illustrating one embodiment of a method for flexibly inputting messages in different input interfaces. Depending on the embodiment, certain of the steps described below may be removed, others may be added, and the sequence of steps may be altered.

In step S10, a plurality of input interfaces corresponding to different mobile phone orientation is set.

In step S20, an item of inputting messages from the main menu of the mobile phone 10 when the mobile phone 10 is in a first orientation is selected.

In step S30, the orientation sensing unit 20 of the mobile phone 10 detects the current orientation of the mobile phone 10.

In step S40, the interface changing unit 50 invokes a first input interface corresponding to the current mobile phone orientation to display on the mobile phone 10.

In step S50, messages are inputted in the first input interface.

In step S60, the mobile phone 10 is rotated to a second orientation and message contents inputted in the first input interface are stored.

In step S70, the first input interface to a second input interface corresponding to the second orientation of the mobile phone 10 is changed and the message contents inputted in the first input interface on the second input interface are displayed for users to continue to edit.

It is to be understood, however, that even though numerous characteristics and advantages of the embodiments have been set forth in the foregoing description, together with details of the structure and function of the present disclosure, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A communication device, comprising:
an orientation sensing unit configured to detect a current orientation of the communication device;
an interface changing unit configured to invoke corresponding input interfaces to display on the communication device according to the current orientation of the communication device when the communication device is in an input mode; and
a message handling unit configured to store message contents inputted in a first input interface and displaying the message contents on a second input interface when the communication device is rotated to another orientation.

2. The communication device system of claim 1, wherein the orientation sensing unit comprises a gravity ball and at least four sensing points symmetrically positioned around the gravity ball; the orientation sensing unit detects the orientation of the communication device via the gravity ball pressing against a corresponding sensing point.

3. The communication device system of claim 1, further comprising an input interface setting unit configured to set a plurality of input interfaces corresponding to a plurality of orientations of the communication device.

4. An input method for a communication device, the method comprising
providing the communication device;
entering into an inputting mode;
detecting a current orientation of the communication device;
displaying a first input interface corresponding to the current orientation of the communication device for users inputting message; and
changing the first input interface to a second input interface when the communication device is rotated to another orientation.

5. The method of claim 4, further comprising setting a plurality of input interfaces corresponding to different orientations of the communication device.

6. The method of claim 5, wherein an orientation sensing unit is positioned in the communication device for sensing the current orientation of the communication device.

7. The method of claim 6, wherein the orientation sensing unit comprises a gravity ball and at least four sensing points symmetrically positioned around the gravity ball, the orientation sensing unit detects an orientation via the gravity ball pressing against one of the sensing points.

8. The method of claim 4, further comprising storing the message contents inputted in the first input interface when the first input interface is changed to the second input interface and displaying the message contents in the second input interface for users to continue to edit.
